(19) United States
(12) Patent Application Publication
(10) Pub. No.: US 2013/0234973 A1
(43) Pub. Date: Sep. 12, 2013

(54) TOUCH SCREEN PANEL AND IMAGE DISPLAY DEVICE INCLUDING SAME

(71) Applicants: Tae Whan Kim, Seoul (KR); Gyu Wan Han, Gyeongbuk (KR); Su Hyeong Park, Gyeongbuk (KR)

(72) Inventors: Tae Whan Kim, Seoul (KR); Gyu Wan Han, Gyeongbuk (KR); Su Hyeong Park, Gyeongbuk (KR)

(73) Assignee: INDUSTRY-UNIVERSITY COOPERATION FOUNDATION HANYANG UNIVERSITY, Seoul (KR)

(21) Appl. No.: 13/989,299

(22) PCT Filed: Nov. 22, 2011
(86) PCT No.: PCT/KR11/08909

§ 371 Date: May 23, 2013

(30) Foreign Application Priority Data
Nov. 24, 2010 (KR) 10 2010-0117538

(51) Int. Cl. G06F 3/041

(52) U.S. Cl. CPC G06F 3/041
USPC 345/173

(57) ABSTRACT

The present invention relates to a touch screen panel and to an image display device including same. The touch screen panel comprises: a first sensing wire pattern layer in which a plurality of first sensing wire pattern lines are formed in a first diagonal direction; a second sensing wire pattern layer in which a plurality of second sensing wire pattern lines are formed in a second diagonal direction so as to form a preset angle with the first sensing wires; and an insulation layer for providing insulation between the 1st sensing wire pattern layer and the 2nd sensing wire pattern layer. Since capacitive touch sensing wire pattern lines are disposed diagonally with a certain angle therebetween, the number of wires arranged on the major axis of the bezel of the touch screen panel can be reduced when compared to the resolution of touch screen panels of prior art in which the arrangement is perpendicular.

### TECHNICAL FIELD

The present invention relates to a touch screen panel and an image display device including the same.

### BACKGROUND ART

Inputs of existing electronic devices have been carried out in a method of performing selection, cancellation, and movement through simple button input. However, this interface method has difficulties in using functions of electronic devices because the electronic devices are operated using restricted buttons. For example, when there is no prior information about an operation method of input buttons when intuitively viewed by a user, it is difficult to input information to an electronic device.

Accordingly, a touch screen panel that is operated by directly touching a screen for an input tool with an intuitive interface so as to reduce the discomfort of the user is very useful to enter information. The touch screen panel is categorized into a resistance film type touch screen panel that is obtained by vertically stacking two transparent conductive resistance films and an electrostatic capacitance type touch screen panel that uses an electrostatic force.

The resistance film type touch screen panel is operated in a method of calculating the location of a touch point as the degree of resistance in X-axis and Y-axis directions using two resistance films, and has been widely used due to its low manufacturing costs and easy applicability to electronic devices or portable electronic devices. However, since coordinates of the location are calculated through the physical contact, a device is liable to wear when the resistance film type touch screen panel is used for an extended period of time. Since a surface of the resistance film type touch screen panel also uses a flexible plastic-based protective layer, the screen panel deteriorates in terms of durability due to scratches. In addition, in the resistance film type touch screen panel, two touches or more may not be detected due to characteristics of a device driving method, and therefore implementation of multi-touch is impossible.

On the other hand, in the electrostatic capacitance type touch screen panel that uses the electrostatic force, each cell of a sensing wire is connected to a touch screen panel controller. The controller transmits measurement signals to each cell corresponding to the sensing wire and receives, from the sensing wire, sensing signals generated by a human body when a touch occurs on a surface of the touch screen. The sensing signals of the horizontal and vertical-axis touch sensing wires are put in coordinates to detect a touch position. Compared to the resistance film type touch screen panel, the electrostatic capacitance type touch screen panel has a complex structure, high manufacturing costs, and decreased sensing efficiency due to occurrence of noise by a small capacity value, but has high transmittance and excellent durability due to its operation by a significantly small pressure.

In the electrostatic capacitance type touch screen panel, there may be no or a very small capacitance value of a sensor when a human body does not touch on the panel, and a capacitance value corresponding to an area between a touch pad and the human body may be detected when the human body touches on the panel.

The touch pad that detects the capacitance may be configured in a variety of forms. The touch pad may be configured in the form of cells in which the touch pad exists at each location, in the form in which a contact area of the touch pad is changed in accordance with the location, or in the form of orthogonal arrays in which horizontal and vertical-axis wires having uniform widths are arrayed orthogonally to each other. Among these, the form in which the horizontal and vertical-axis wires are orthogonally arranged is the most common form.

Since a portable image display device has a rectangular shape in which a vertical axis is relatively longer than a horizontal axis, an existing touch screen panel in the form of orthogonal arrays, which is applied to the portable image display device, is configured in such a manner that the number of vertical-axis sensing wires of the touch sensing wire is larger than the number of horizontal-axis sensing wire thereof.

FIG. 1 is a schematic plan view showing a touch screen panel according to the prior art.

As shown in FIG. 1, the touch screen panel according to the prior art includes a plurality of sensing areas 10 and 20 and sensing wires 30 and 40. The plurality of sensing areas 10 and 20 may include vertical sensing areas 10 and horizontal sensing areas 20. The sensing wires 30 and 40 are connected to a touch panel controller 50. The touch panel controller 50 receives touch sensing signals through the sensing areas 10 and 20 from the sensing wires 30 and 40, and transmits the touch sensing signals to a device including a touch screen panel. The touch sensing signals include position information of the sensing areas 10 and 20. In general, a touch screen panel in the form of orthogonal arrays, which is widely used, has an orthogonal touch sensing unit. Here, in the touch screen panel, a horizontal-axis sensing wire pattern line and a vertical-axis sensing wire pattern line are configured in the form of orthogonal arrays.

Since screens of many portable image display devices have a rectangular shape in which a vertical-axis is longer than a horizontal-axis, many sensing wires and metal wires for connecting the sensing wires through the touch panel controller are positioned in a lateral long axis rather than a short axis.

However, in accordance with the spread of portable equipment including the image display device, users prefer a larger screen in small portable devices.

In accordance with the trend of increase in a size of the image display device according to the user's needs for the larger screen and needs for touch resolution to meet the trend, the number of horizontal and vertical-axis sensing wires is increased.

In addition, when the touch resolution is increased for accurate coordinate recognition in the same screen size, the number of vertical-axis wires which are long axes in the touch screen panel in the form of orthogonal arrays is further increased while the number of the touch sensing wires is accordingly increased.

Accordingly, a width of a bezel of the image display device for screening the sensing wires is increased, which causes limitation of an area that is relatively occupied by a screen of the image display device in the portable equipment with a limited size.

In order to implement an image display device having a large screen while the portable equipment has a small size, the touch screen panel in the form of orthogonal arrays in which the vertical and horizontal-axis wire pattern lines are arrayed orthogonal to each other has a structural disadvantage.

In a structure in which the number of the vertical-axis touch sensing wires is larger than the number of the horizontal-axis touch sensing wires, the vertical-axis wires which are long axes may cause an increase in a width of the bezel, and may not increase a size of the screen of the image display device within the limited size of the portable equipment.

### DISCLOSURE

### Technical Problem

The present invention is directed to providing a touch screen panel which may minimize a width of a bezel by reducing the number of long-axis sensing wires while equally providing an existing touch resolution, thereby maximizing a size of a screen of an image display device within a limited size of portable equipment.

The present invention is also directed to providing an image display device including the touch screen panel.

### Technical Solution

One aspect of the present invention provides a touch screen panel including: a first sensing wire pattern layer in which a plurality of first sensing wire pattern lines are formed in a first diagonal direction; a second sensing wire pattern layer in which a plurality of second sensing wire pattern lines are formed in a second diagonal direction so as to form a predetermined angle with the first sensing wires; and an insulation layer that provides insulation between the first sensing wire pattern layer and the second sensing wire pattern layer.

The predetermined angle may belong to one of a range greater than 0 degrees and smaller than 90 degrees and a range greater than 90 degrees and smaller than 180 degrees.

The first sensing wire pattern line may be connected to a sensing wire disposed in a long axis of the touch screen panel, and the second sensing wire pattern line may be connected to a sensing wire disposed in a short axis of the touch screen panel.

The angle may be determined in such a manner that the number of sensing lines connected to the first and second touch sensing wire pattern lines is reduced compared to a touch screen panel in an orthogonal form.

A unit sensing area formed in such a manner that the first sensing wire pattern lines and the second sensing wire pattern lines cross each other may have a lozenge shape.

Another aspect of the present invention provides a touch screen panel including: a plurality of first sensing wire pattern lines that are patterned in a first diagonal direction; a plurality of second sensing wire patter lines that are patterned in a second diagonal direction so as to form a predetermined angle with the first sensing wire pattern lines; and insulation pattern units that are formed between the first sensing wire pattern lines and the second sensing wire pattern lines to provide insulation between the first sensing wire pattern lines and the second sensing wire pattern lines.

The first and second sensing wire pattern line layers may be formed on the same substrate.

The first sensing wire pattern line may include a plurality of first patterns and a first bridge unit that includes a plurality of bridge portions for connecting two first patterns spaced apart from each other among the plurality of first patterns in the first direction, and the second sensing wire pattern line may include a plurality of second patterns and a second bridge unit that includes a plurality of bridge portions for connecting two second patterns spaced apart from each other among the plurality of second patterns in the second direction.

The insulation pattern unit may be formed on the plurality of bridge portions of the first sensing wire pattern line to insulate the plurality of bridge portions of the first sensing wire pattern lines and the plurality of bridge portions of the second sensing wire pattern lines.

Still another aspect of the present invention provides an image display device including: a touch screen panel that includes a first sensing wire pattern layer in which a plurality of first sensing wire pattern lines are formed in a first diagonal direction, a second sensing wire pattern layer in which a plurality of second sensing wire pattern lines are formed in a second diagonal direction so as to form a predetermined angle with the first sensing wire pattern lines, and an insulation layer that provides insulation between the first sensing wire pattern layer and the second sensing wire pattern layer; first detection lines that are disposed in a long axis of the touch screen panel and connected to the first sensing wire pattern lines to detect a sensing signal; second detection lines that are disposed in a short axis of the touch screen panel and connected to the second sensing wire pattern lines to detect a sensing signal; and a touch panel controller that receives the sensing signal from the first and second detection lines and converts a coordinate value in accordance with the sensing signal into a coordinate value of a Cartesian coordinate system.

Yet another aspect of the present invention provides an image display device including: a touch screen panel that includes a plurality of first sensing wire pattern lines that are patterned in a first diagonal direction, a plurality of second sensing wire patter lines that are patterned in a second diagonal direction so as to form a predetermined angle with the first sensing wire pattern lines, and insulation pattern units that are formed between the first sensing wire pattern lines and the second sensing wire pattern lines to provide insulation between the first sensing wire pattern lines and the second sensing wire pattern lines; first detection lines that are disposed in a long axis of the touch screen panel and connected to the first sensing wire pattern lines to detect a sensing signal; second detection lines that are disposed in a short axis of the touch screen panel and connected to the second sensing wire pattern lines to detect a sensing signal; and a touch panel controller that receives the sensing signal from the first and second detection lines and converts a coordinate value in accordance with the sensing signal into a coordinate value of a Cartesian coordinate system.

### Advantageous Effects

According to the present invention, lateral sensing wire pattern lines in a diagonal direction having a predetermined angle which are different from a pattern in which horizontal and vertical-axis sensing wires cross each other are formed, thereby reducing the number of sensing wires positioned in a long axis of an image display device. As a result, according to the present invention, it is possible to reduce a width of a bezel (an edge portion that screens data wires of the image display device) of the image display device.

Also, according to the present invention, a width of a bezel may be reduced within a limited size of a portable device in order to meet user's needs for a large screen of the image display device in the portable device, thereby manufacturing a relatively wide image display device.

### DESCRIPTION OF DRAWINGS

FIG. 1 is a schematic plan view showing a touch screen panel according to the prior art;

FIG. 2 is a schematic plan view showing a touch screen panel according to an embodiment of the present invention;

FIG. 3 is an exploded perspective view showing a touch screen panel according to an embodiment of the present invention;

FIG. 4 is a view showing unit touch sensing areas in a sensing wire pattern line structure in an orthogonal form according to the prior art and in a sensing wire pattern line structure in a diagonal form according to an embodiment of the present invention;

FIG. 5 is an exploded perspective view showing a touch screen panel according to another embodiment of the present invention;

FIG. 6 is a view showing a touch screen panel in which layers shown in FIG. 5 are combined;

FIG. 7 is a view showing a method of manufacturing a touch screen panel according to another embodiment of the present invention;

FIG. 8 is an exploded perspective view showing the touch screen panel of FIG. 7;

FIG. 9 is a view showing a pattern of a bridge unit for the touch screen panel of FIG. 8;

FIG. 10 is a schematic view defining the number of wires in designing a diagonal sensing wire pattern according to an embodiment of the present invention;

FIG. 11 is a view showing a method of calculating a coordinate value in a diagonal sensing wire pattern line structure according to an embodiment of the present invention;

FIG. 12 is a view showing two sensing wire coordinate axes corresponding to an actual panel model;

FIG. 13 is a view showing coordinates when touching arbitrary coordinates P in an image display device;

FIG. 14 is a view describing primary rotation conversion according to an embodiment of the present invention; and

FIG. 15 is a view describing primary movement conversion according to an embodiment of the present invention.

### MODES OF THE INVENTION

Hereinafter, exemplary embodiments of the present invention will be described in detail. However, the present invention is not limited to the exemplary embodiments disclosed below, but can be implemented in various forms. The following exemplary embodiments are described in order to enable those of ordinary skill in the art to embody and practice the invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used here, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined here.

According to the present invention, in an image display device in which a long axis of a touch screen panel is vertically disposed, two axes of a capacitive touch sensing wire coordinate system is designed and disposed to have a predetermined angle therebetween, so that a large number of touch sensing wires are positioned in a short axis direction rather than a long axis direction in the touch screen panel having the same touch resolution, thereby reducing the number of long-axis sensing wires that affect a width of a bezel.

Hereinafter, embodiments of the present invention will be described in detail with reference to the accompanying drawings.

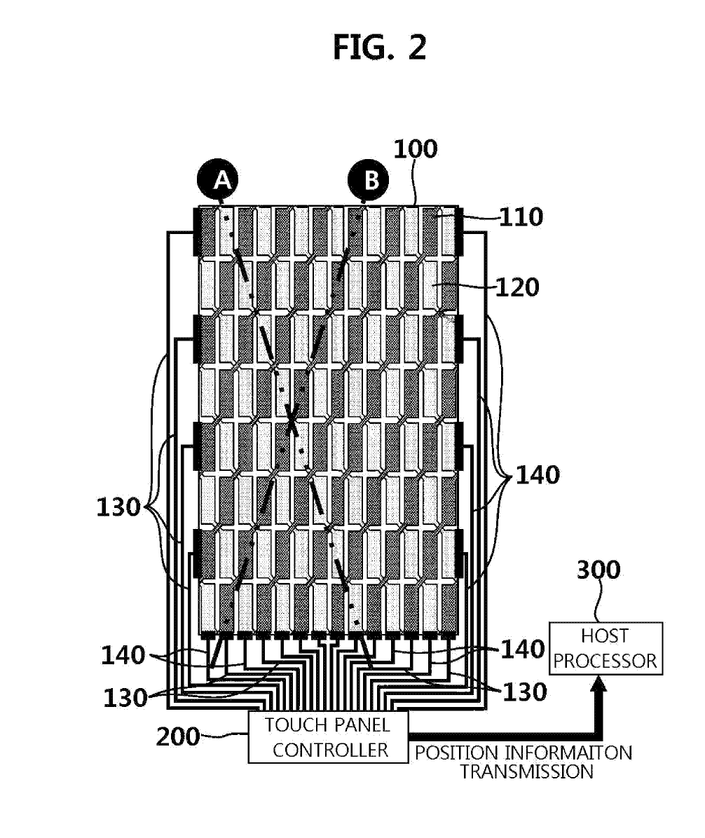

FIG. 2 is a schematic plan view showing a touch screen panel 100 according to an embodiment of the present invention.

The touch screen panel 100 according to an embodiment of the present invention includes a plurality of first sensing wire pattern lines 110 in a first diagonal direction (direction B of FIG. 2) and a plurality of second sensing wire pattern lines 120 in a second diagonal direction (direction A of FIG. 2).

Each of the plurality of first sensing wire pattern lines 110 is connected to a touch panel controller 200 through first detection lines 130 (or sensing wires). Each of the plurality of second sensing wire pattern lines 120 is connected to the touch panel controller 200 through second detection lines 140 (or sensing wires).

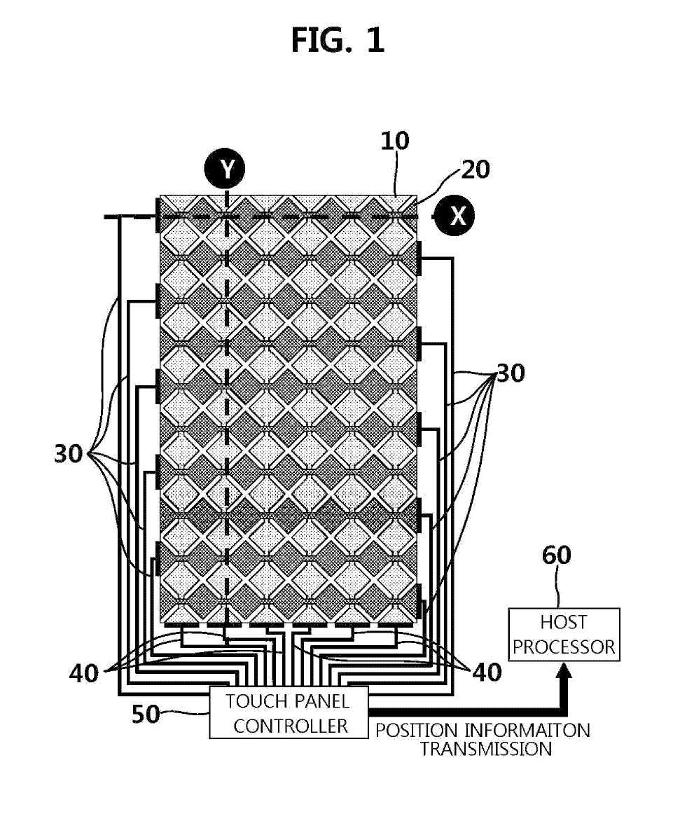

In the touch screen panel according to an embodiment of the present invention which is shown in FIG. 2, lateral sensing wire patterns in a diagonal direction, which has a predetermined angle, are arranged, thereby reducing the number of sensing wires positioned in a long axis of the image display device, compared to a pattern in which horizontal axis and vertical axis sensing wire patterns cross each other in the touch screen panel shown in FIG. 1.

For example, the number of sensing wires in the long axis direction in FIG. 1 is 5, and the number of first sensing wire pattern lines 110 in the first diagonal direction (B direction) that meets the long axis in FIG. 2 is 4.

Therefore, the number of detection lines for connecting the first sensing wire pattern lines 110 to the touch panel controller 200 is also 5 in FIG. 1, but is reduced to 4 in FIG. 2. Referring to FIG. 2, a small number of sensing wire pattern lines and detection lines are appeared to be reduced, but a large number of sensing wire pattern lines or a large number of detection lines with respect to the entire touch screen panel are reduced.

In this manner, according to an embodiment of the present invention, a width of a bezel may be reduced by reducing the number of sensing wires in the long axis direction while providing the same touch resolution as that in the existing touch screen panel.

In this manner, in the touch screen panel according to an embodiment of the present invention, a larger number of metal wires connected to the touch panel controller 200 are designed to be arranged in a short axis direction that does not affect the width of the bezel, thereby reducing the number of sensing wires arranged in a lateral long axis direction while maintaining the same touch resolution.

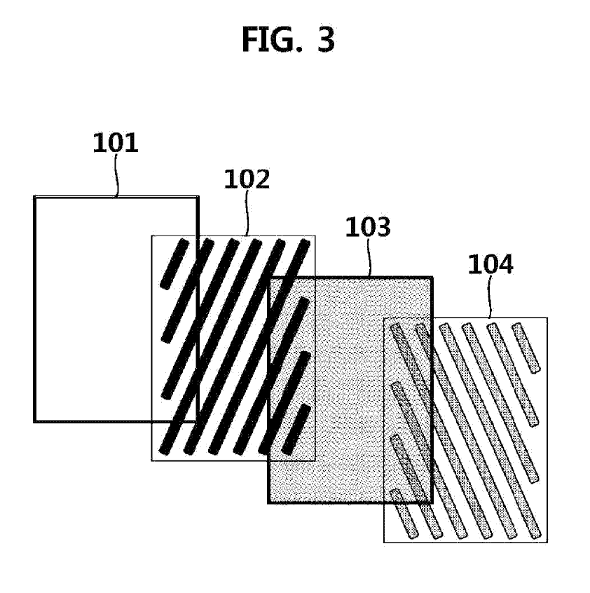

FIG. 3 is an exploded perspective view showing a touch screen panel according to an embodiment of the present invention.

Referring to FIG. 3, the touch screen panel 100 includes a plurality of layers 101 to 104. Specifically, the touch screen panel 100 includes touch sensing units 102, 103, and 104 and a touch glass layer 101.

The touch sensing unit includes a first sensing wire pattern layer 102 disposed in a lower portion of the touch glass layer 101, a second sensing wire pattern layer 104, and a transparent dielectric layer 103 disposed between the first sensing wire pattern layer 102 and the second sensing wire pattern layer 104.

The touch glass layer 101 is a top layer of the touch screen panel and may be made of an optically transparent material. The touch glass layer 101 may be a chemically reinforced glass, a transparent plastic, or other substrates.

The touch glass layer 101 that is the top layer may serve as a touch surface of the touch screen panel, and a touch sensing unit is formed below the touch glass layer 101. The touch glass layer 101 may protect the touch sensing unit against environmental hazards and serve as a dielectric layer that is essential for capacitive touch between an object to be touched and the sensing unit.

The first touch sensing wire pattern layer 102 and the second touch sensing wire pattern layer 104 include a plurality of touch sensing wire pattern lines which are symmetrically arranged side by side in a lateral diagonal direction while having a predetermined angle therebetween.

Sensing areas are formed by the sensing wire pattern lines formed on the first sensing wire pattern layer 102 and the second sensing wire pattern layer 104. These sensing areas include a series of areas connected to each other in a narrow rectangular form of small pieces.

When the wire pattern layers are simultaneously sensed in this sensing structure, the upper layer 102 (first sensing wire pattern layer) is shielded from the lower layer 104 (second sensing wire pattern layer) except for a deficiency area between the sensing wire pattern lines where the sensing wires of the second sensing wire pattern layer are capacitatively coupled.

The touch sensing wire patterns generally include indium tin oxide (ITO) having high optical transparency, other transparent conductive polymers, or transparent conductive oxides. Alternatively, the sensing unit that does not affect a screen of the image display device may be made of an opaque metallic conductive material.

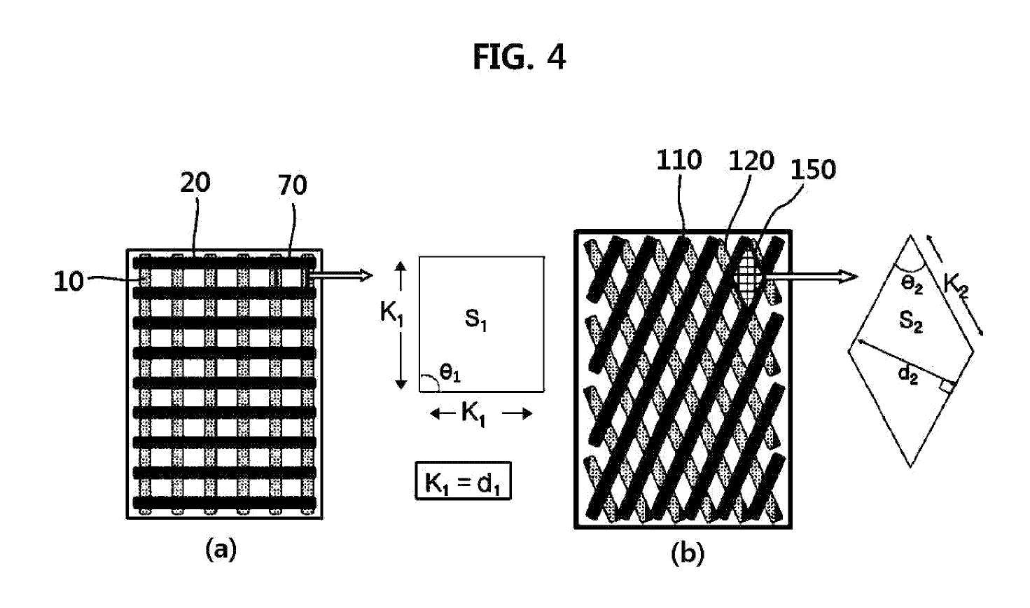

FIG. 4 is a view showing unit touch sensing areas in a sensing wire pattern line structure in an orthogonal form according to the prior art and in a sensing wire pattern line structure in a diagonal form according to an embodiment of the present invention.

Referring to FIG. 4, in a left figure, a rectangular unit sensing area 70 formed by the touch sensing wire pattern lines in the orthogonal form which is mainly used in a general touch screen panel of the prior art is S₁.

A unit length in the sensing wire pattern line in the orthogonal form is K₁, an interval between two parallel wire pattern lines is d₁, and an angle θ₁ formed by two sensing wire pattern lines that cross each other is 90°.

Referring to FIG. 4, in a right figure, in the sensing wire pattern line structure in the diagonal form, a rhombus-shaped sensing area formed by first direction sensing wire pattern lines 110 and second direction sensing wire pattern lines 120 is designed as a unit sensing area.

An area of the rhombus-shaped unit sensing area formed by the first direction sensing wire pattern lines 110 and the second direction sensing wire pattern lines 120 is S₂. A pattern of determining the number of touch sensing wires may be designed in such a manner that a length K₂ that is a unit length of the unit sensing area, a wire interval d₂ between the sensing wire pattern lines, and an angle θ₂ formed by the first direction sensing wire pattern lines 110 and the second direction sensing wire pattern lines 120 are defined, and a width of a bezel may be reduced while having appropriate touch resolution through the following Equation using a design parameter.

As shown in the embodiment of FIG. 4, even when the two sensing wire pattern layers 102 and 104 are simultaneously operated, it is possible to have a combination on a point on the two sensing wire pattern layers.

In this instance, the touch sensing area S₂ may have a variety of shapes including a rectangular shape. A size of the touch sensing area and a height to width ratio thereof may be selected so that a typical finger covers a part of the sensing unit on each layer. Since areas of the screens of the image display devices are the same in the sensing wire pattern design according to the prior art and the sensing wire pattern design according to the present invention, the number of unit sensing areas should be the same so that touch resolutions of the two touch sensing systems are the same. Accordingly, the areas S₁ and S₂ of the unit sensing areas are the same and the touch resolutions thereof are the same.

The area of the unit sensing area is defined as S=K²·sin θ by an angle θ₂ between the unit length K and the sensing wire. Since a unit length is K₁ and the angle θ₁ between the sensing wires is 90° in the orthogonal area S₁, S₁=K₁² is satisfied.

In addition, since a unit length is K₂ and an angle between the sensing wires is θ₂ in a rhombus-shaped area S₂, S₂=K₂²·sin θ₂ is satisfied.

S₁=S₂ so that the touch resolutions are the same, and therefore K₁²=K₂²·sin θ₂ is satisfied. As a result,

$${K}_{2} = \frac{{K}_{1}}{\sqrt{sin {θ}_{2}}}$$

is satisfied. An interval d₁ between the sensing wire pattern lines in the orthogonal unit sensing area and an interval d₂ between the sensing wire pattern lines in the rhombus-shaped unit sensing area are obtained through relationship between each of sensing unit lengths K₁ and K₂.

Since d₁=K₁ and d₂=K₂·sin θ₂ are satisfied, d₂=K₁\sqrt{sin θ₂} is satisfied when substituting

$${K}_{2} = \frac{{K}_{1}}{\sqrt{sin {θ}_{2}}}$$

in Equation concerning d₂.

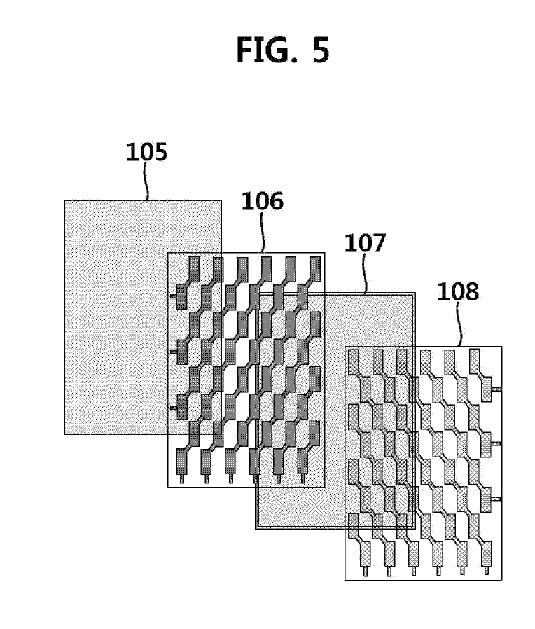

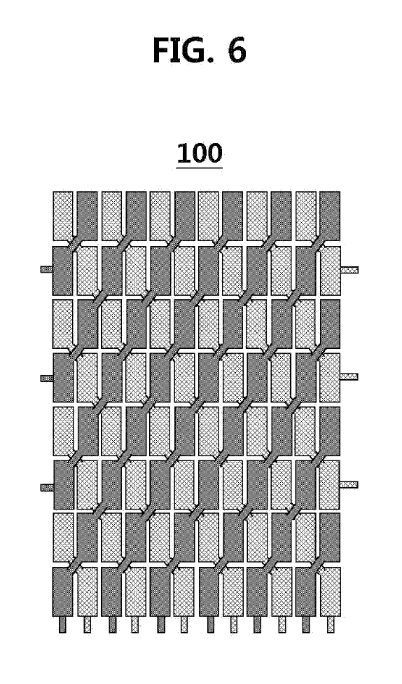

FIG. 5 is an exploded perspective view showing a touch screen panel according to another embodiment of the present invention, and FIG. 6 is a view showing a touch screen panel in which layers shown in FIG. 5 are combined.

The touch screen panel shown in FIG. 5 has a similar configuration as that of the touch screen panel shown in FIG. 3, but shapes of sensing wire pattern lines that are patterned on the first and second touch sensing wire pattern layers 106 and 108 are different from shapes of the sensing wire pattern lines of FIG. 3.

In the sensing wire pattern lines shown in FIGS. 5 and 6, the touch sensing pattern lines are patterned on the first touch sensing wire pattern layer 106 or the second touch sensing wire pattern layer 108, and a plurality of pattern lines included in the touch sensing pattern lines are connected through a bridge unit.

In this case, the pattern lines on the first touch sensing wire pattern layer 106 are arranged so as not to be overlapped with the pattern lines on the second touch sensing wire pattern layer 108.

In the touch screen panel of FIG. 5, a transparent dielectric layer 107 disposed between the first sensing wire pattern layer 106 and the second sensing wire pattern layer 108 serves as an insulation layer, and therefore between the first sensing wire pattern layer 106 and the second sensing wire pattern layer 108 is insulated.

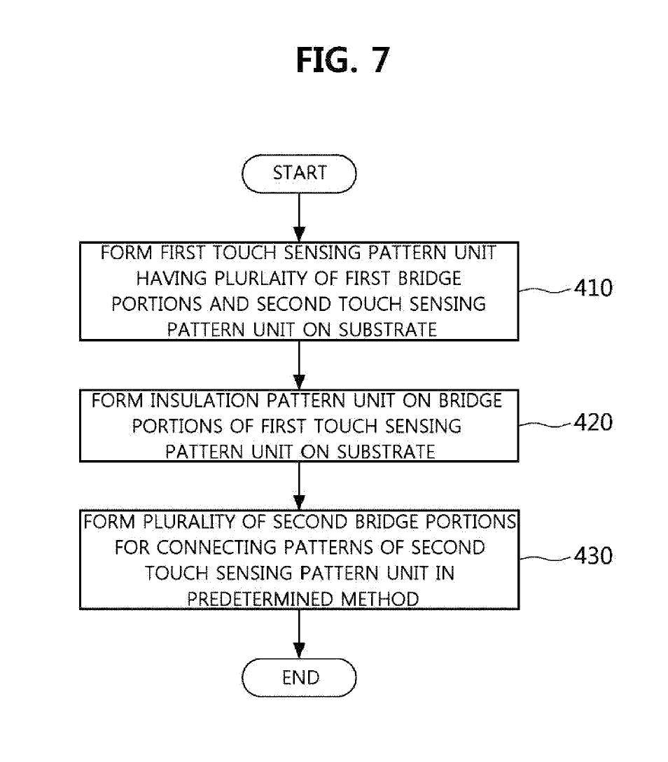

The touch screen panel according to an embodiment of the present invention may be manufactured in the methods shown in FIGS. 7, 8, and 9.

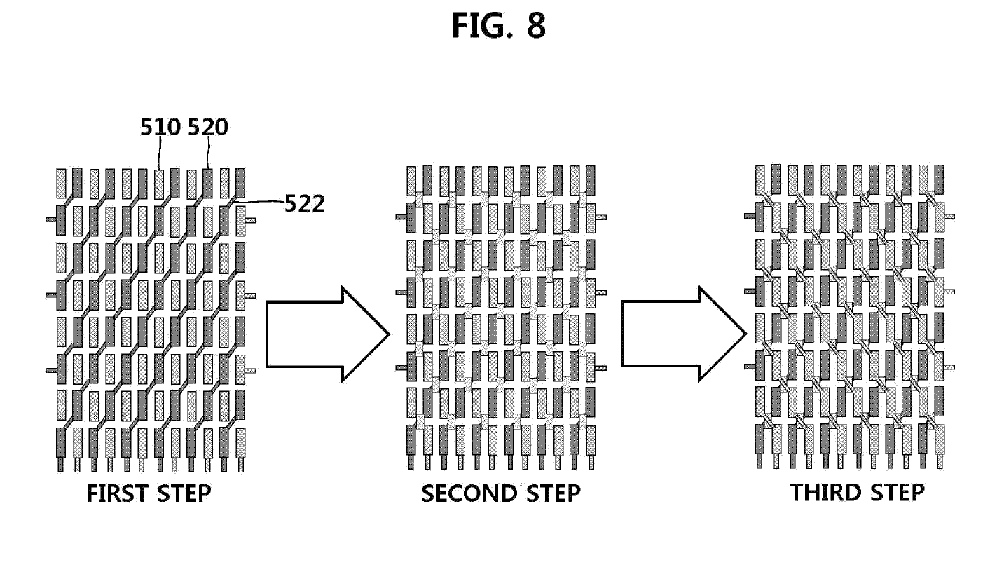

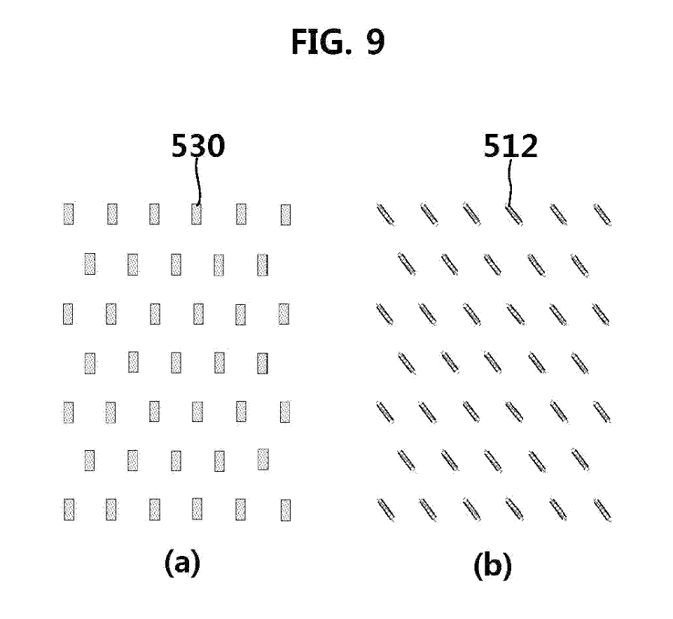

FIG. 7 is a view showing a method of manufacturing a touch screen panel according to another embodiment of the present invention, FIG. 8 is an exploded perspective view showing the touch screen panel of FIG. 7, and FIG. 9 is a view showing a pattern of a bridge unit for the touch screen panel of FIG. 8.

In a method of manufacturing a touch screen panel according to another embodiment of the present invention, in a first step (step 410), a first sensing wire pattern having a plurality of first bridge portions and a second sensing wire pattern line are formed on a substrate.

Referring to FIG. 8, the first sensing wire pattern line (520 or the first touch sensing pattern unit) include a first bridge portions 522. That is, the plurality of patterns of the first sensing wire pattern line (520 or the first touch sensing pattern unit) are connected by the first bridge portions 522 to form the sensing wire pattern lines. In this instance, the first bridge portions 522 connect the plurality of patterns of the first sensing wire pattern line 520 along a first direction. In addition, the second sensing wire pattern line 510 may be also patterned on the substrate.

In a second step (step 420), an insulation pattern unit 530 on the bridge portions 522 of the first sensing wire pattern line (520 or the first touch sensing pattern unit) is formed on the substrate.

For example, as shown (a) of FIG. 9, the insulation pattern unit 530 is formed on the substrate. The insulation pattern unit 530 is used so as to insulate the plurality of first bridge portions 522 of the first sensing wire pattern line 520 and the second bridge portions 512 of the second sensing wire pattern line 510.

The bridge portions 522 of the first sensing wire pattern line 520 and the bridge portions 512 of the second sensing wire pattern line 510 should be insulated from each other. Accordingly, before forming the second bridge portions 512 of the second sensing wire pattern line 510 on the substrate, the insulation pattern unit 530 is formed on the first bridge portion 522 of the first sensing wire pattern line 520.

Next, in a third step (step 430), the plurality of second bridge portions 512 for connecting the patterns of the sensing pattern unit 510 of the second sensing wire pattern line in a predetermined method, for example, a method in which the patterns are connected in a second direction are formed on the substrate.

For example, as shown in (b) of FIG. 9, the plurality of second bridge portions 512 are formed on the substrate.

As a result, the touch screen panel may be manufactured through three steps of FIG. 8.

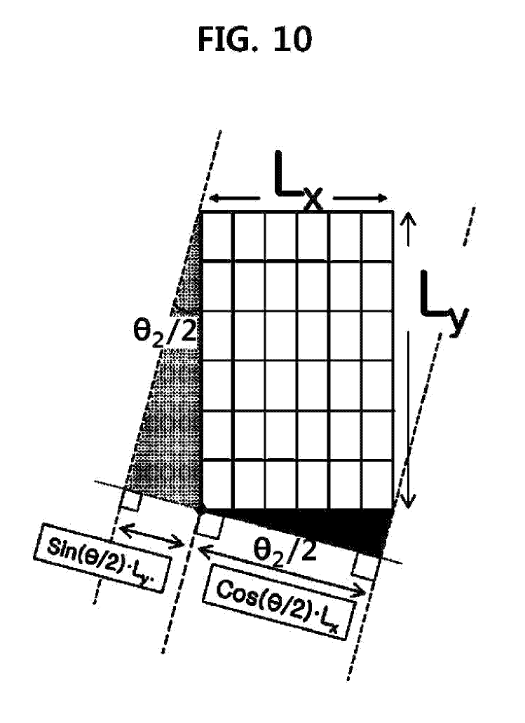

FIG. 10 is a schematic view defining the number of wires in designing a diagonal sensing wire pattern according to an embodiment of the present invention

When dividing the entire width in one side sensing wire pattern line direction by an interval d between sensing wire pattern lines, the number of wires disposed in the direction is defined. When a length of a short axis is defined as Lₓ and a length of a long axis is defined as L_{y}, an angle between two left and right wires is θ₂, and therefore a value

$${L}_{y} \cdot sin \frac{{θ}_{2}}{2}$$

obtained by multiplying the length L_{y} of the long axis by a sin function of a half of the angle θ₂/2 is the entire width disposed diagonally from the side of the long axis.

When dividing, the entire width

$${L}_{y} \cdot sin \frac{{θ}_{2}}{2}$$

in which the diagonal detection wire pattern lines are arranged by a distance d₂ between the sensing wire pattern lines, the number of touch sensing wire pattern lines positioned in a diagonal long axis may be obtained.

That is, the number of sensing wire pattern lines in one side diagonal direction is

$$\frac{{L}_{y} \cdot sin \frac{{θ}_{2}}{2}}{{d}_{2}} .$$

In the touch screen panel having the same touch resolution, the number of sensing wires disposed in the side of the long axis L_{y} in the conventional orthogonal design is L_{y}/d₁, and the number of the entire wires in the long axis side by the diagonal design according to an embodiment of the present invention is

$$2 \times \frac{{L}_{y} \cdot sin \frac{{θ}_{2}}{2}}{{d}_{2}}$$

which is double of the number of wires in one side diagonal direction because the wires are arranged on both sides.

The number of touch sensing wire pattern lines in the structure according to the present invention should be smaller than the number of orthogonal sensing wire pattern lines

$$\frac{{L}_{y}}{{d}_{1}}$$

when compared to the number of the touch sensing wire pattern lines in the conventional orthogonal structure.

Accordingly, the number of touch sensing wire pattern lines according to the present invention is

$$2 \times \frac{{L}_{y} \cdot sin \frac{{θ}_{2}}{2}}{{d}_{2}} ≺ \frac{{L}_{y}}{{d}_{1}} .$$

In this instance, when substituting d₁=K₁ and d₂=K₁\sqrt{sin θ₂},

$$\frac{2 {L}_{y} \cdot sin \frac{{θ}_{2}}{2}}{{K}_{1} \sqrt{sin {θ}_{2}}} < \frac{{L}_{y}}{{K}_{1}}$$

is obtained.

Accordingly, an angle for satisfying

$$\frac{sin \frac{{θ}_{2}}{2}}{\sqrt{sin {θ}_{2}}} < \frac{1}{2}$$

may be θ₂<53.13°. That is, in the diagonal wire pattern line design, when an angle between the first sensing wire pattern lines and the second sensing wire pattern lines is smaller than 53.13°, the number of wires on the long axis side is reduced compared to the conventional orthogonal wire pattern line design.

In addition, when θ₂<53.13° is satisfied, reduction efficiency (R.E.) of the number of side wires is

$$R . E . = 1 - \frac{2 \cdot sin \frac{{θ}_{2}}{2}}{\sqrt{sin {θ}_{2}}} .$$

Since the reduction efficiency is a function only by the angle θ₂, the reduction efficiency may not be decreased even though a size of the image display device is changed.

Since the reduction efficiency is not changed even though the short axis and the long axis of the image display device are increased, the number of wires that is reduced along with an increase in the size is proportionally increased.

Accordingly, the diagonal wire pattern line design method according of an embodiment of the present invention has an advantage of reducing the number of wires along with an increase in the touch resolution.

In this manner, when touch occurs in the touch screen panel in which the sensing wire pattern lines are formed in the diagonal direction, coordinate information in accordance with signals sensed through the touch sensing wire pattern lines is input to the touch panel controller 200 through detection lines (or sensing wires) corresponding to each of the wire pattern lines.

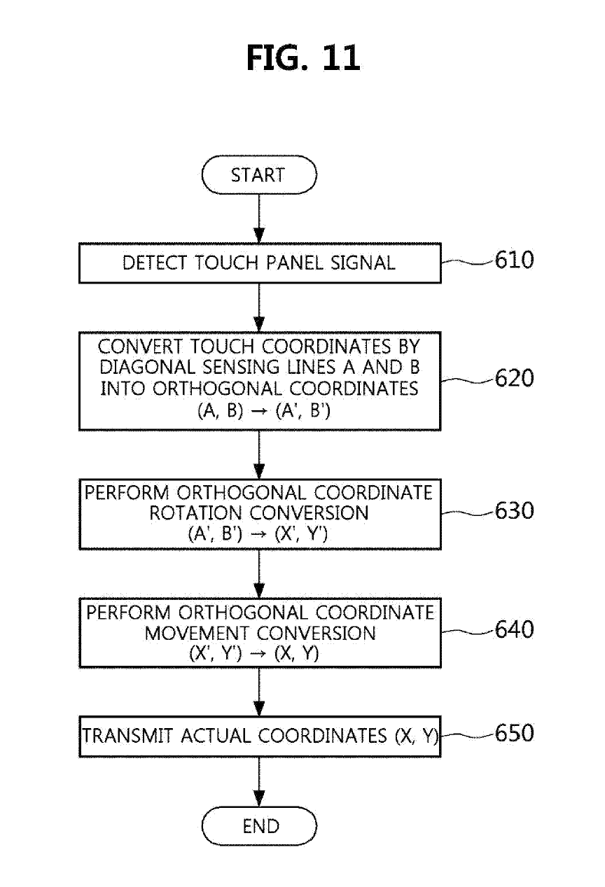

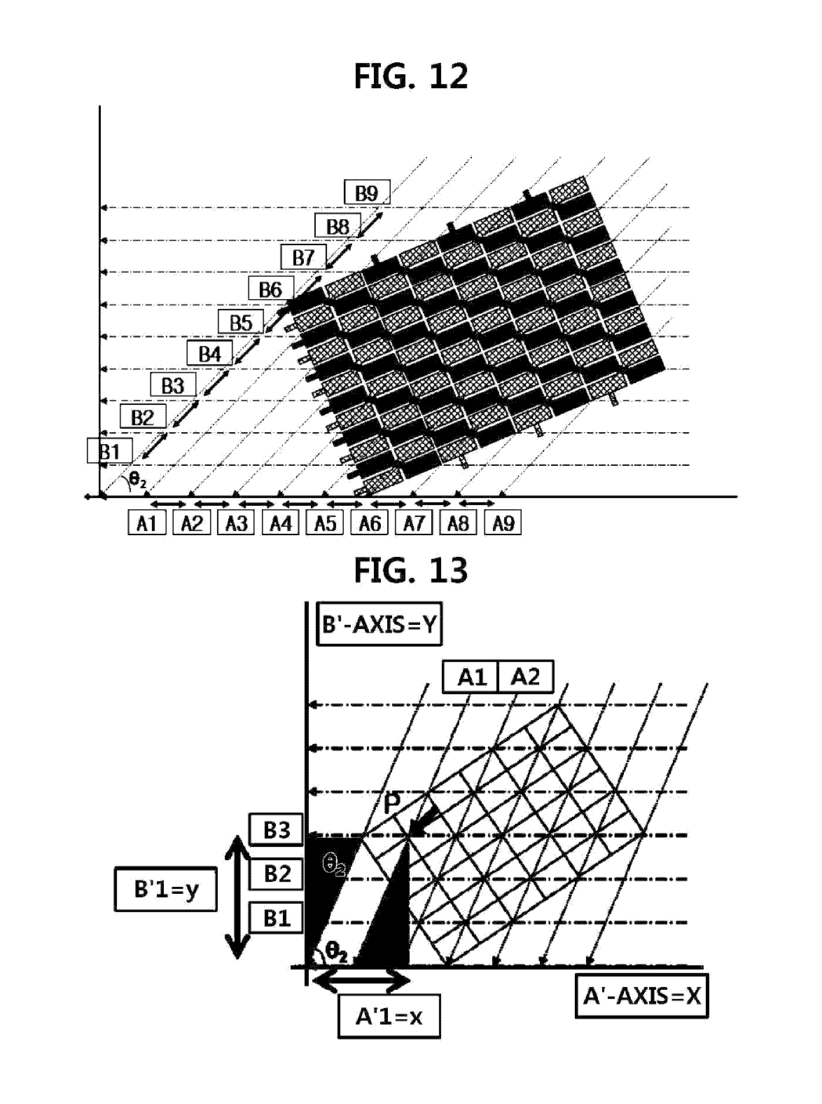

FIG. 11 is a view showing a method of calculating a coordinate value in a diagonal sensing wire pattern line structure according to an embodiment of the present invention, and FIGS. 12 to 15 are views describing the calculation method of FIG. 11.

Referring to FIG. 11, in step 610, when a touch panel signal is detected, the touch panel controller 200 proceeds to step 620 and converts touch coordinates by diagonal sensing lines A and B into orthogonal coordinates.

Here, the touch panel controller 200 may be implemented by software using an arithmetic calculation function of converting the touch coordinates into the orthogonal coordinates, or by hardware so as to perform a function of converting the touch coordinates into the orthogonal coordinates.

FIG. 12 is a view showing two sensing wire coordinate axes corresponding to an actual panel model. Axes of the sensing wires in the first and second directions cross each other with a predetermined angle Θ₂, and therefore are not orthogonal to each other.

In the sensing wires in the first and second directions, a coordinate system (A, B) having an angle θ₂ is referred to as touch sensing coordinates, and a coordinate system used in the existing touch sensing device is referred to as an orthogonal touch sensing coordinate system (x, y). In this case, in order to use a processor operated in the existing coordinate system as is, conversion to the orthogonal touch sensing coordinate system (x, y) is required.

In order to convert coordinates of a diagonal axis wire that senses touch in FIG. 12 into orthogonal coordinates, an A-axis is associated with an X-axis.

Accordingly, a change amount of A-axis is the same as a change amount of X-axis, and a change amount of B-axis is different from a change amount of Y-axis.

FIG. 13 is a view showing coordinates when touching arbitrary coordinates P in an image display device. Coordinates recognized by the touch sensing coordinate system (A, B) are represented as orthogonal coordinates (A′, B′) on x-y orthogonal coordinates.

Specifically, when touching the arbitrary touch coordinates p, a position conversion process on general x-y orthogonal coordinates may be performed under a condition in which reduction and increase in A-axis coordinates are the same as reduction and increase in X-axis coordinates. In FIG. 13, when x coordinate of the touch coordinates P is calculated using an A coordinate value and a B coordinate value, A′=A+B_{cos θ}₂ is obtained.

When y coordinate B′ is calculated using the B coordinate value corresponding to a length of an inclined plane of a triangle, B′=B sin θ₂ is obtained. A determinant of these A′ and B′ is as the following.

$$\begin{matrix}{A}^{′} = A + B cos {θ}_{2} \\ {B}^{′} = B sin {θ}_{2}\end{matrix} ⇒ ( \begin{matrix}{A}^{′} \\ {B}^{′}\end{matrix} ) = ( \begin{matrix}1 & cos {θ}_{2} \\ 0 & sin {θ}_{2}\end{matrix} ) ( \begin{matrix}A \\ B\end{matrix} )$$

The touch panel controller 200 converts touch coordinates by diagonal sensing lines A and B into orthogonal coordinates, and then performs orthogonal coordinate rotation conversion in step 630.

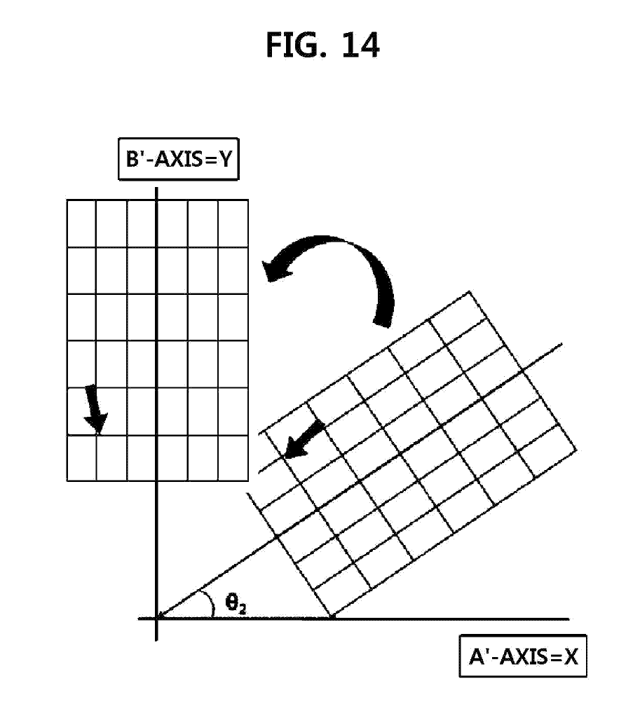

FIG. 14 is a view describing primary rotation conversion according to an embodiment of the present invention.

Referring to FIG. 14, a diagonal coordinate system is moved through primary rotation conversion by 90′−θ₂/2 with respect to a Y-axis. In this instance, a used matrix formula of the primary rotation conversion is as the following.

$$( \begin{matrix}{X}^{′} \\ {Y}^{′}\end{matrix} ) = ( \begin{matrix}sin ( \frac{θ}{2} ) & - cos ( \frac{θ}{2} ) \\ cos ( \frac{θ}{2} ) & sin ( \frac{θ}{2} )\end{matrix} ) ( \begin{matrix}1 & cos θ \\ 0 & sin θ\end{matrix} ) ( \begin{matrix}A \\ B\end{matrix} ) + ( \begin{matrix}\frac{Lx}{2} \\ - \frac{Lx}{2} cot ( θ / 2 )\end{matrix} )$$

Next, in step 640, the touch panel controller 200 performs orthogonal coordinate movement conversion.

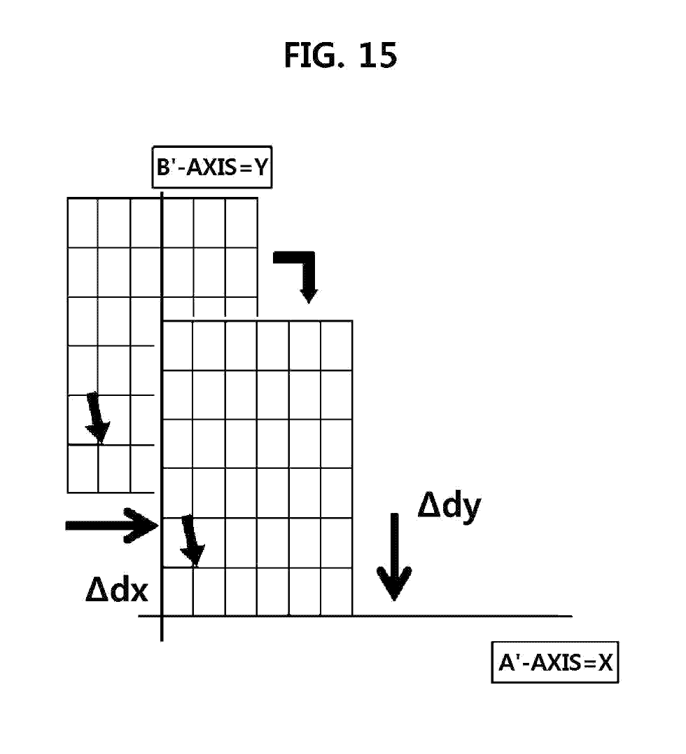

FIG. 15 is a view describing primary movement conversion according to an embodiment of the present invention.

As shown in FIG. 15, conversion is performed through primary parallel movement conversion by an X-axis parallel movement distance Δdx and a Y-axis parallel movement distance Δdy in the same manner as the orthogonal touch sensing coordinate system (x−y), and a used matrix formula is as the following.

$$Δ dx = Lx / 2$$

$$Δ dy = Δ dx cot ( θ / 2 ) \\ ⇒ ( \begin{matrix}X \\ Y\end{matrix} ) = ( \begin{matrix}{X}^{′} \\ {Y}^{′}\end{matrix} ) + ( \begin{matrix}Δ dx \\ - Δ dy\end{matrix} )$$

Therefore, initial sensing coordinates (A, B) with respect to the touch point P are converted into orthogonal coordinates (A′, B′), rotationally converted (X′, Y′), and then finally primary movement-converted (X, Y).

$$\begin{matrix}⇒ ( \begin{matrix}X \\ Y\end{matrix} ) = ( \begin{matrix}cos ( \frac{π}{2} - \frac{{θ}_{2}}{2} ) & - sin ( \frac{π}{2} - \frac{{θ}_{2}}{2} ) \\ sin ( \frac{π}{2} - \frac{{θ}_{2}}{2} ) & cos ( \frac{π}{2} - \frac{{θ}_{2}}{2} )\end{matrix} ) ( \begin{matrix}{A}^{′} \\ {B}^{′}\end{matrix} ) \\ = ( \begin{matrix}sin ( \frac{{θ}_{2}}{2} ) & - cos ( \frac{{θ}_{2}}{2} ) \\ cos ( \frac{{θ}_{2}}{2} ) & sin ( \frac{{θ}_{2}}{2} )\end{matrix} ) ( \begin{matrix}{A}^{′} \\ {B}^{′}\end{matrix} )\end{matrix}$$

That is, the touch panel controller 200 perform the primary rotation conversion and the primary movement conversion with respect to the converted coordinates (A′. B′) so as to obtain coordinates (x, y) in the x-y orthogonal coordinate system.

Therefore, the corresponding coordinates are subjected to the primary rotation conversion and the parallel movement conversion so that the corresponding coordinates are positioned on the general x-y orthogonal coordinates, and then the coordinate system (A-B) with respect to the touch screen panel is converted into (x, y) on the existing orthogonal touch (x-y) sensing coordinate system to be input to the existing processor.

In the above-described embodiments, in order to convert a coordinate value of a sensing signal in the touch screen panel in which the sensing wire pattern lines are formed in the diagonal direction into a coordinate value of an orthogonal coordinates, the orthogonal coordinate value is calculated whenever touch occurs.

However, the present invention is not limited thereto. For example, a mapping table in which the coordinate value of the orthogonal coordinates is mapped to correspond to the coordinate value of the sensing signal in the touch screen panel in which the sensing wire pattern lines are formed in the diagonal direction may be provided in advance, and when the sensing signal is generated, an orthogonal coordinate value corresponding to the generated sensing signal is read from the mapping table, thereby increasing a processing speed.

As described above, according to the embodiments of the present invention, in the touch screen panel and the image display device including the same, two axes of the capacitive touch sensing wire pattern line are arranged in the diagonal form having a predetermined angle between the two axes, so that a larger number of touch sensing wires are positioned in a short-axis direction of a bezel of the touch screen panel compared to resolution of the touch screen panel in the form of orthogonal array, thereby reducing the number of wires arranged in a long axis. Therefore, a width of the edge bezel of the image display device that screens the touch sensing wire may be reduced, and therefore an area of the image display device may be increased within a limited size of a portable device, and a design effect may be obtained as the bezel becomes thinner.

In addition, according to the embodiments of the present invention, when resolution of the touch screen panel is increased along with an increase in the size of the image display device, higher resolution may be used in the same size of the panel.

In addition, using a coordinate conversion method of the existing orthogonal touch sensing wire pattern line without a separate additional area with respect to the touch sensing wire pattern line in the diagonal direction, an area using orthogonal coordinate information may be used as is.

In this specification, exemplary embodiments of the present invention have been classified into the first, second, and third exemplary embodiments and described for conciseness. However, respective steps or functions of an exemplary embodiment may be combined with those of another exemplary embodiment to implement still another exemplary embodiment of the present invention.

While the invention has been shown and described with reference to certain exemplary embodiments thereof, it will be understood by those skilled in the art that various changes in form and details may be made therein without departing from the spirit and scope of the invention as defined by the appended claims.

1. A touch screen panel comprising:
a first sensing wire pattern layer in which a plurality of first sensing wire pattern lines are formed in a first diagonal direction;
a second sensing wire pattern layer in which a plurality of second sensing wire pattern lines are formed in a second diagonal direction so as to form a predetermined angle with the first sensing wires; and
an insulation layer that provides insulation between the first sensing wire pattern layer and the second sensing wire pattern layer.

2. The touch screen panel of claim 1, wherein the predetermined angle belongs to one of a range greater than 0 degrees and smaller than 90 degrees and a range greater than 90 degrees and smaller than 180 degrees.

3. The touch screen panel of claim 1, wherein the first sensing wire pattern line is connected to a sensing wire disposed in a long axis of the touch screen panel, and the second sensing wire pattern line is connected to a sensing wire disposed in a short axis of the touch screen panel.

4. The touch screen panel of claim 1, wherein the angle is determined in such a manner that the number of sensing lines connected to the first and second touch sensing wire pattern lines is reduced compared to a touch screen panel in an orthogonal form.

5. The touch screen panel of claim 4, wherein a unit sensing area formed in such a manner that the first sensing wire pattern lines and the second sensing wire pattern lines cross each other has a lozenge shape.

6. A touch screen panel comprising:
a plurality of first sensing wire pattern lines that are patterned in a first diagonal direction;
a plurality of second sensing wire patter lines that are patterned in a second diagonal direction so as to form a predetermined angle with the first sensing wire pattern lines; and
insulation pattern units that are formed between the first sensing wire pattern lines and the second sensing wire pattern lines to provide insulation between the first sensing wire pattern lines and the second sensing wire pattern lines.

7. The touch screen panel of claim 6, wherein the first and second sensing wire pattern line layers are formed on the same substrate.

8. The touch screen panel of claim 7, wherein the first sensing wire pattern line includes a plurality of first patterns and a first bridge unit that includes a plurality of bridge portions for connecting two first patterns spaced apart from each other among the plurality of first patterns in the first direction, and the second sensing wire pattern line includes a plurality of second patterns and a second bridge unit that includes a plurality of bridge portions for connecting two second patterns spaced apart from each other among the plurality of second patterns in the second direction.

9. The touch screen panel of claim 8, wherein the insulation pattern unit is formed on the plurality of bridge portions of the first sensing wire pattern line to insulate the plurality of bridge portions of the first sensing wire pattern lines and the plurality of bridge portions of the second sensing wire pattern lines.

10. An image display device comprising:
a touch screen panel that includes a first sensing wire pattern layer in which a plurality of first sensing wire pattern lines are formed in a first diagonal direction, a second sensing wire pattern layer in which a plurality of second sensing wire pattern lines are formed in a second diagonal direction so as to form a predetermined angle with the first sensing wire pattern lines, and an insulation layer that provides insulation between the first sensing wire pattern layer and the second sensing wire pattern layer;
first detection lines that are disposed in a long axis of the touch screen panel and connected to the first sensing wire pattern lines to detect a sensing signal; second detection lines that are disposed in a short axis of the touch screen panel and connected to the second sensing wire pattern lines to detect a sensing signal; and a touch panel controller that receives the sensing signal from the first and second detection lines and converts a coordinate value in accordance with the sensing signal into a coordinate value of a Cartesian coordinate system.

11. The image display device of claim 10, wherein the predetermined angle belongs to one of a range greater than 0 degrees and smaller than 90 degrees and a range greater than 90 degrees and smaller than 180 degrees.

12. An image display device comprising: a touch screen panel that includes a plurality of first sensing wire pattern lines that are patterned in a first diagonal direction, a plurality of second sensing wire patter lines that are patterned in a second diagonal direction so as to form a predetermined angle with the first sensing wire pattern lines, and insulation pattern units that are formed between the first sensing wire pattern lines and the second sensing wire pattern lines to provide insulation between the first sensing wire pattern lines and the second sensing wire pattern lines;
first detection lines that are disposed in a long axis of the touch screen panel and connected to the first sensing wire pattern lines to detect a sensing signal;
second detection lines that are disposed in a short axis of the touch screen panel and connected to the second sensing wire pattern lines to detect a sensing signal; and
a touch panel controller that receives the sensing signal from the first and second detection lines and converts a coordinate value in accordance with the sensing signal into a coordinate value of a Cartesian coordinate system.

13. The image display device of claim 12, wherein the predetermined angle belongs to one of a range greater than 0 degrees and smaller than 90 degrees and a range greater than 90 degrees and smaller than 180 degrees.
